(19) United States
(12) Patent Application Publication
(10) Pub. No.: US 2014/0117858 A1
(43) Pub. Date: May 1, 2014

(54) LIGHT CONTROLLER AND METHOD FOR CONTROLLING LIGHTS

(71) Applicant: Donald H. Jacobs, St. Louis, MO (US)

(72) Inventor: Donald H. Jacobs, St. Louis, MO (US)

(21) Appl. No.: 13/803,967

(22) Filed: Mar. 14, 2013

Related U.S. Application Data
(60) Provisional application No. 61/718,790, filed on Oct. 26, 2012.

(51) Int. Cl. H05B 37/02; G01J 1/00

(52) U.S. Cl. CPC H05B 37/02; G01J 1/00
USPC 315/152; 250/200

(57) ABSTRACT

A method of estimating the occurrence of midnight on a given day comprises the steps of determining the average night length (NLAVE) by averaging the night lengths (NL) between a night starting time (NST) as determined by a photosensor and a night ending time (NET) determined by a photosensor for each of a plurality of days, and estimating midnight to occur at the time that is one half of the average night length (NLAVE) after the night starting time (NST) for the given day. This estimate of midnight to control the operation of lights or other equipment without the need for clocks or constant power.

### CROSS-REFERENCE TO RELATED APPLICATIONS

This application claims the benefit of U.S. Provisional Application No. 61/718,790, filed on Oct. 26, 2012. The entire disclosure of the above application is incorporated herein by reference.

### FIELD

The present disclosure relates to light controllers and methods of controlling lights, and in particular to light controllers that operate outdoor lighting systems, such as those in parking lots.

### BACKGROUND

This section provides background information related to the present disclosure which is not necessarily prior art.

A significant area for reducing energy consumption is outdoor lighting, such as the lighting of large parking lots with pole mounted luminaires. While it is important to provide lighting when people are present, substantial savings could be had if the lights could be switched to a lower level, when people are not present. However, high intensity discharge (HID) lamps typically used in these applications do not respond quickly when turned off and on in an attempt to save energy. Alternatively introducing a means to change light levels (and their associated energy levels) of the HID lamps without allowing the arc inside the lamp to extinguish would enable the lamp to instantaneously respond to the various passive and active control methodologies.

Active control methodologies would include the use of motion sensors to operate the HID lamps at full intensity only when people are present. In contrast, passive control methodologies would leave the lamps operating at full intensity during the times when people are likely to be present, and only operate them at low intensity during times when people are less likely to be present. This type of control, however, requires information about the current time, and it is difficult to retrofit a control with reliable time keeping to a plurality of individual lights, and keep the time for each control accurate and synchronized with the other controls when power to the pole lighting assembly is interrupted by an external switching process. Typically, the lights are only powered during the evening time, and without power the controls cannot maintain the current time.

### SUMMARY

This section provides a general summary of the disclosure, and is not a comprehensive disclosure of its full scope or all of its features.

Embodiments of the present invention provide a lighting control, and a method of controlling lights, that allow operating of the lights at different intensities and energy consumption levels based in part upon the time of day. Some of these embodiments eliminate the need to set the time or to synchronize for individual controllers on multiple lights. According to one embodiment, a method is provided for estimating the time so that lights can be controlled based in part upon the daylight cycle. This method can, for example, estimate the occurrence of midnight, and based upon that estimate, estimate the occurrence of other times relative to midnight. Based upon these estimates, the control can change the operation of the lamps based upon the approximate time of day. For example, when the lights are turned on at night, each control can provide full power to its respective lamp for a predetermined period of time, and at a particular time in the evening, reduce the power to the lamp to operate it at reduced power, whereupon the control can resume full power operation of the lamp for a predetermined time. This time based control of the lamp can be accomplished without providing each control with a clock or similar time keeping device, or otherwise having to set and synchronize a clock or time keeping device.

According to one embodiment of the invention, a method of estimating the occurrence of midnight on a given day is provided. The method can comprise the steps of determining the average night length (NLAVE) by averaging the night lengths (NL) between a night starting time (NST) as determined by a photosensor and a night ending time (NET) determined by a photosensor for each of a plurality of days. Midnight is then estimated as occurring at a time that is one half of this average night length (NLAVE) after the night starting time (NST) for the given day. The plurality of days for which the average night length (NLAVE) is determined, is preferably a predetermined number of days, for example, three days, immediately preceding the given day. In some embodiments, the days used in determining the average night length (NLAVE) are a predetermined number of days immediately preceding the given day whose night length (NL) meets a predetermined criteria, such as a meeting a minimum or maximum length.

According to another embodiment of this invention, a method of controlling the operation of lights is provided. According to the preferred embodiment of the method, the operation of one or more lights are controlled (changed) based upon the estimated time, which is at a predetermined offset from the estimated occurrence of midnight. This estimated occurrence of midnight can be made by determining the average night length (NLAVE) by averaging the night lengths (NL) between a night starting time (NST) as determined by a photosensor, and a night ending time (NET) determined by a photosensor for each of a plurality of days. Midnight is then estimated as occurring at a time that is one half of this average night length (NLAVE) after the night starting time (NST) for the given day. The plurality of days for which the average night length (NLAVE) is determined, is preferably a predetermined number of days, for example three days, immediately preceding the given day. In some embodiments, the days used in determining the average night length (NLAVE) are a predetermined number of days immediately preceding the given day whose night length (NL) meets a predetermined criteria, such as meeting a minimum or maximum length.

According to still another embodiment of this invention, a control is provided for controlling at least one light in an outdoor lighting system. The control preferably includes a relay for operating the at least one light; at least one photosensor; and a processor programmed to estimate the occurrence of midnight on the current day by determining the average night length (NLAVE) by averaging the night lengths (NL) between a night starting time (NST) as determined by the at least one photosensor and a night ending time (NET) determined by the at least one photosensor for each of a plurality of days, and estimating midnight on the current day to occur at the time that is one half of the average night length (NLAVE) after the night starting time (NST) for the current day, and operate the relay to control the at least one light at a predetermined period of time offset from the estimated occurrence of midnight. In one embodiment, the control further comprises a motion sensor, and the relay controls the light to operate under control of the motion sensor.

According to an alternate embodiment of a control in accordance with this invention, a control is provided that operates at least one light in a lighting system at reduced power after a predetermined time, unless triggered by a motion sensor. The control preferably includes a relay for operating the at least one light; at least one photosensor; a motion sensor; and a processor programmed to estimate the occurrence of midnight on the current day. The processor preferably estimates the occurrence of midnight by determining the average night length (NLAVE) by averaging the night lengths (NL) between a night starting time (NST) as determined by the at least one photosensor and a night ending time (NET) determined by the at least one photosensor for each of a plurality of days, and estimating midnight on the current day to occur at the time that is one half of the average night length (NLAVE) after the night starting time (NST) for the current day. The control can operate the relay to control the at least one light at a predetermined period of time offset from the estimated occurrence of midnight.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of one preferred embodiment of a light controller in accordance with the principles of this invention;

FIG. 2 is a schematic diagram of an embodiment of a light controller according to the principles of this invention, as it could be installed on a typical outdoor lighting fixture;

FIG. 3 is an exploded view of the embodiment shown schematically in FIG. 2;

FIG. 4 is a front elevation view of the housing;

FIG. 5 is a right side elevation view of the housing;

FIG. 6 is a rear elevation view of the housing;

FIG. 7 is a left side elevation view of the housing;

FIG. 8 is a top plan view of the housing;

FIG. 9 is a bottom plan view of the housing;

FIG. 10 is a front elevation view of an alternate housing for housing for use with a round pole mounting a single light;

FIG. 11 is a rear elevation view of the alternate housing;

FIG. 12 is a right side elevation view of the alternate housing;

FIG. 13 is a left side elevation view of the alternate housing;

FIG. 14 is a top plan view of the alternate housing; and

FIG. 15 is a bottom plan view of the alternate housing.

Corresponding reference numerals indicate corresponding parts throughout the several views of the drawings.

### DETAILED DESCRIPTION

Example embodiments will now be described more fully with reference to the accompanying drawings.

A first preferred embodiment of this invention provides a method of estimating the occurrence of midnight on a given day. According to the method of this preferred embodiment, the average night length (NLAVE) is determined by averaging the night lengths (NL) between a night starting time (NST) as determined by a photosensor and a night ending time (NET) determined by a photosensor for each of a plurality of days. Midnight is estimated to occur at the time that is one half of the average night length (NLAVE) after the night starting time (NST) for the given day. Of course some fraction of the (NLAVE) other than one half could be used in the estimation of the occurrence of midnight.

The plurality of days for which the average night length (NLAVE) is determined, are preferably a predetermined number of days immediately preceding the given day.

The average night length (NLAVE) is preferably determined over the three days immediately preceding the given day. While the (NLAVE) could be determined over fewer (for example one or two days) or more (for example four or seven) days, it is believed that three days provides a suitably accurate determination that overcomes variances that might occur because of temporary weather or lighting conditions that could affect a measurement of a single night, but which allows for an accurate estimation, in view of the changing night starting time (NST), night ending time (NET), and the resulting night length (NL).

In an alternate embodiment, the night lengths (NL) that are used in the calculation of the average night length (NLAVE) are screened relative to a predetermined criteria. For example, a night length that is less than a predetermined minimum, or exceeds a predetermined maximum, or which varies by more than a predetermined amount (in absolute terms or by percentage) from other recent night lengths (NL) or average night length (NLAVE) might be excluded from the calculation of the average night length (NL), or another recent night length (NL) used in its place, for example an older night length (NL) measurement can be used, one of the night lengths that met the criteria can be overweighted, or a prior (NLAVE) could be used in the calculation of the current (NLAVE).

According to another preferred embodiment of this invention, a method of controlling the operation of an outdoor lighting system is provided. The method can include changing the operation of at least one light in the lighting system at a change time that is a selected offset from the estimated occurrence of midnight. This estimated occurrence of midnight is made by determining the average night length (NLAVE) by averaging the night lengths (NL) between a night starting time (NST) as determined by a photosensor, and a night ending time (NET) determined by a photosensor for each of a plurality of days. Midnight is estimated to occur at the time that is one half of the average night length (NLAVE) after the night starting time (NST) for the current day. Of course some fraction of the (NLAVE) other than one half could be used in the estimation of the occurrence of midnight.

The plurality of days for which the average night length (NLAVE) is determined are preferably a predetermined number of days immediately preceding the given day. The average night length (NLAVE) is preferably determined over the three days immediately preceding the given day. While the (NLAVE) could be determined over fewer (for example, one or two days) or more (for example, four or seven) days, it is believed that three days provides a suitably accurate determination that overcomes variances that might occur because of temporary weather or lighting conditions that could affect a measurement of a single night, but which allows for an accurate estimation, in view of the changing night starting time (NST), night ending time (NET), and the resulting night length (NL).

In an alternate embodiment, the night lengths (NL) that are used in the calculation of the average night length (NLAVE) are screened relative to a predetermined criteria. For example, a night length (NL) that is less than a predetermined minimum, or exceeds a predetermined maximum, or which varies by more than a predetermined amount (in absolute terms or by percentage) from other recent night lengths (NL) or average night length (NLAVE) might be excluded from the calculation of the average night length (NL), or another recent night length (NL) used in its place, for example an older night length (NL) measurement can be used, one of the night lengths that met the criteria can be overweighted, or a prior (NLAVE) could be used in the calculation of the current (NLAVE).

In one embodiment, the time based change caused by the control is that the light is operated at reduced power, and more preferably the light is operated at reduced power unless triggered by a sensor, such as an optical sensor (e.g., an IR sensor), an acoustic sensor, or a motion sensor.

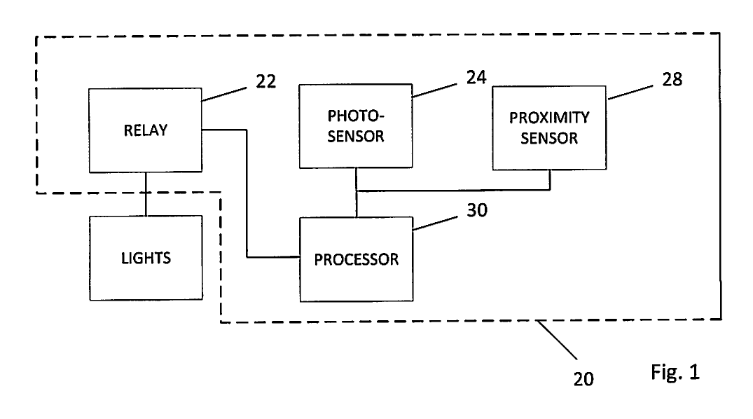

According to another preferred embodiment of this invention, a control is provided for controlling the operation of an outdoor lighting system. The control, indicated generally as 20 in FIG. 1, preferably comprises a relay 22 for operating at least one light in the lighting system. The control 20 includes at least one photosensor 24 for determining the night starting time (NST). The photosensor 24 can also determine the night ending time (NET), or a separate photosensor can be provided for that purpose. Typically only a single sensor is needed, and it is oriented toward the north. When two photosensors are provided, one can be oriented for detection of the night starting time (for example, facing west) and one can be oriented for detection of the night ending time (for example, facing east). The control also comprises a processor 26 programmed to estimate the occurrence of midnight on the current day by determining the average night length (NLAVE) by averaging the night lengths (NL) between a night starting time (NST) as determined by the at least one photosensor and a night ending time (NET) determined by the at least one photosensor for each of a plurality of days. The control estimates midnight on the current day to occur at the time that is one half of the average night length (NLAVE) after the night starting time (NST) for the current day. The control operates the relay 22 to control the at least one light at a predetermined period of time offset from the estimated occurrence of midnight.

The control 20 preferably includes a proximity sensor 28 for detecting the presence of a person, for example an optical sensor (e.g., an IR sensor), an acoustic sensor, or a motion sensor. The relay 22 controls the light to operate in response to the proximity sensor 28. Thus, the light may operate in full power mode until a predetermined time relative to the estimated occurrence of midnight, and thereafter, operate at reduced power, unless the presence of a person is detected.

The control 20 preferably also contains a processor 30, programmed to control the lights. When the lights are first turned on, the control allows the lights to operate at full power for a predetermined time, to enable the lights to function properly. In response to the determination of local sunrise and sunset by the photosensor 24, the processor estimates the occurrence of midnight, as described above. From the estimated occurrence of midnight, the processor 30 can apply a predetermined offset to change the operation of the lights at an approximation of a predetermined time. In this preferred embodiment the processor 26 causes the relay 22 to operate the lights at reduced power for a predetermined period of time. In response to the proximity sensor 28, detecting the presence of people near the light, the processor 30 can operate the relay 22 to operate the lights at a higher power. After a predetermined time and/or when the proximity sensor 28 no longer detects the presence of people, the processor 26 can operate the relay 22 to return the lights to low power. After a predetermined period of time, at an approximate predetermined time, and/or when the photosensors 24 detect morning, the processor 26 can operate the relay 22, again changing the intensity status (lower or off) of the lights to await the next evening cycle.

Thus, the control 20 can be readily retrofit to provide selective timed-based, two-stage operation of HID lights, without the need for an elaborate or expensive control, without the need for a clock and the need to maintain correct clock setting, and without the need for constant power. As long as the control is powered at sunset through sunrise, it can estimate midnight and provide approximate time-based control of the lights.

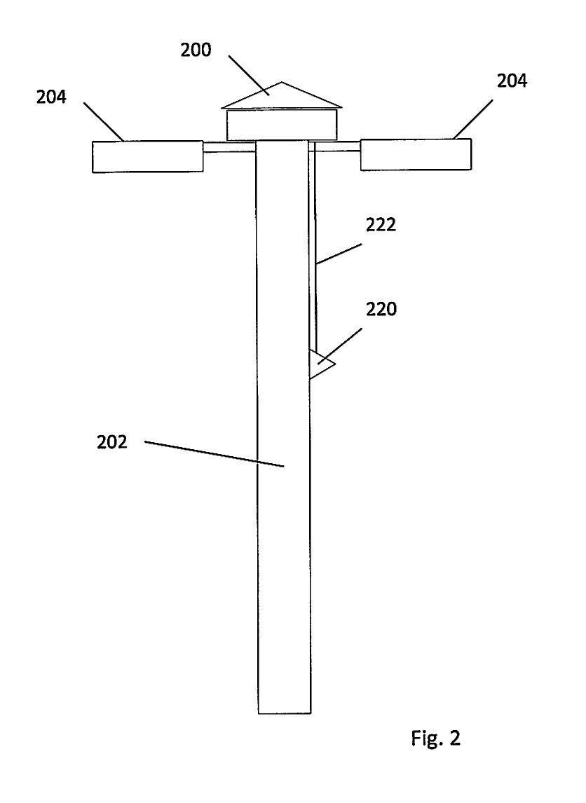

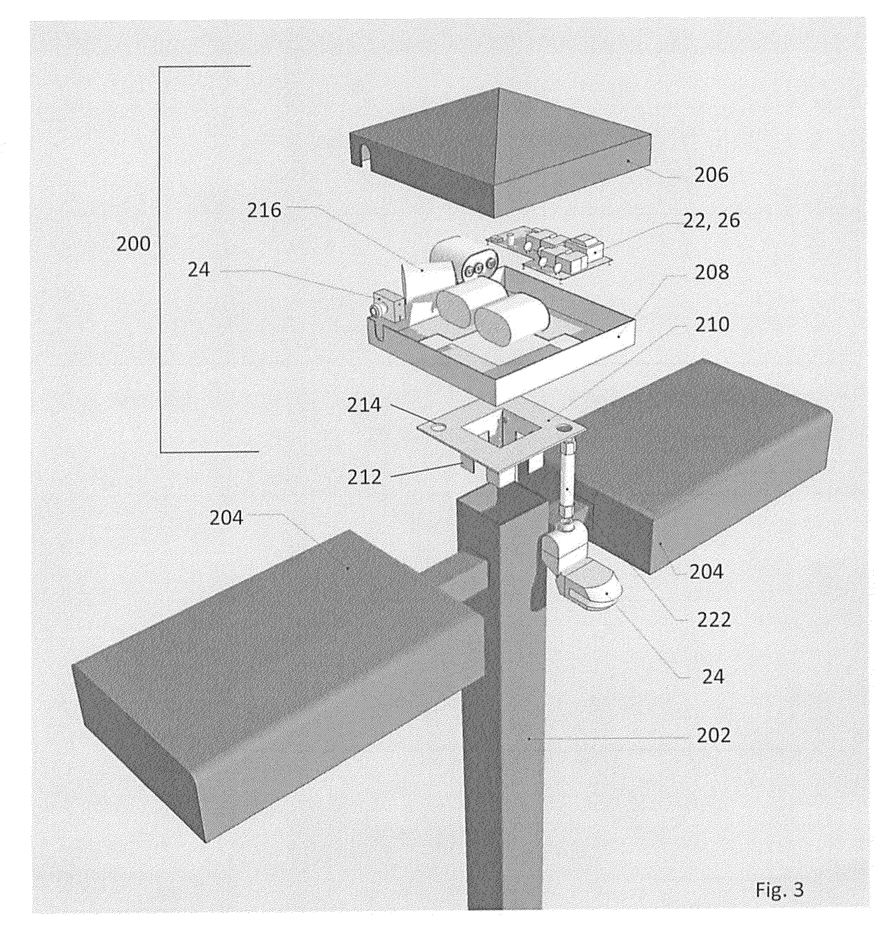

As shown in FIGS. 2 and 3, the control 20 can be provided in a housing 200 adapted to be mounted on the top of a conventional square or circular light pole 202, mounting one or more lights 204. The housing 200 has a cap 206 shaped like a four-sided pyramid. The cap 206 covers a generally square base 208 in which the control components can be mounted, and connected with the power from the lighting system. The bottom of the base 208 has a mounting bracket 210, with depending flanges 212, with cutouts for accommodating the mountings for the lights 204. The flanges have a shape corresponding to the shape of the light pole 202, to fit over or more preferably in, the light pole. The mounting bracket 210 has closeable access openings 214, for making connections to external components, such as the proximity sensors 28 of the control 20 described above.

The box also contains the control 20 and two stage capacitors 216 for operating the lights 204 at two different power levels, under the direction of control 20. As many as four capacitors 216 can be provided in the enclosure (as shown) for controlling the lights 204. The photosensor 24 of the control 20 is also provided, and as noted above is preferably oriented to the north.

As shown in FIG. 3, the proximity sensor 28 of control 20 is mounted on the light pole 202, for detecting the presence of people for the control. A connector 222 connects the proximity sensor 28 to remainder of the control in the housing 200.

Table 1 shows the power savings that can be achieved, in both Watt, and by percentage, in operating High Pressure Sodium lights and Metal Halide lights of different wattages at low power levels. These values are

| | | | | | |
|---|---|---|---|---|---|
| | High | Low | Watts | % | Lumen Output % |
| Lamp | Level | Level | Saved | Saved | at Low Level |

High Pressure Sodium

| | | | | | |
|---|---|---|---|---|---|
| 400 W | 465 | 186 | 279 | 60 | 25 |
| 250 W | 305 | 134 | 171 | 56 | 27 |
| 150 W | 190 | 70 | 120 | 63 | 13 |

Metal Halide

| | | | | | |
|---|---|---|---|---|---|
| 400 W | 460 | 218 | 242 | 53 | 26 |
| 250 W | 307 | 150 | 157 | 51 | 29 |
| 175 W | 215 | 114 | 101 | 47 | 33 |

illustrative of the types of savings available, the actual savings depending upon the types of lights and the specific “low” level chosen for operation.

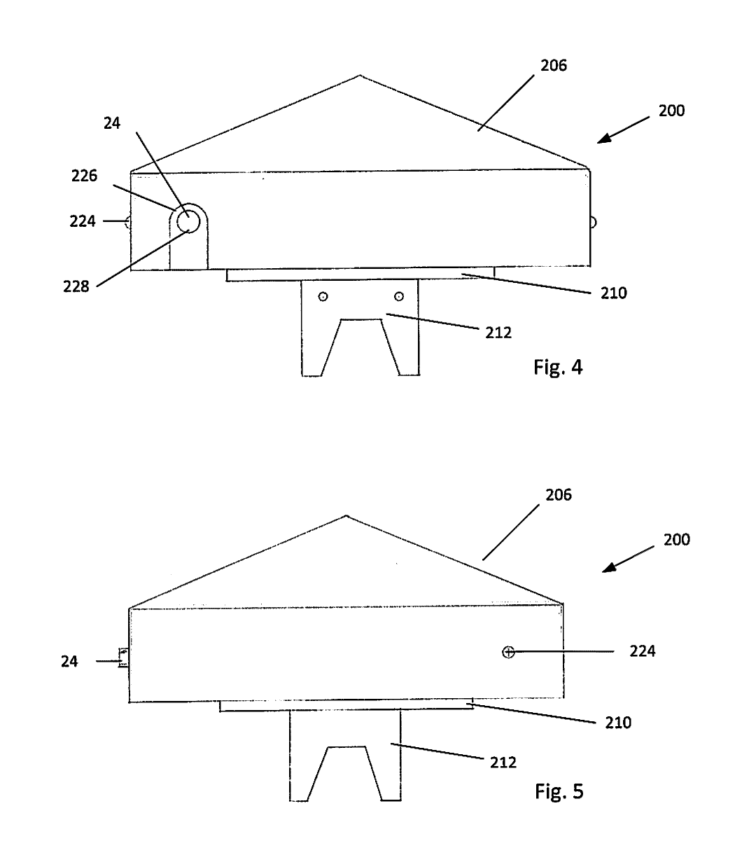

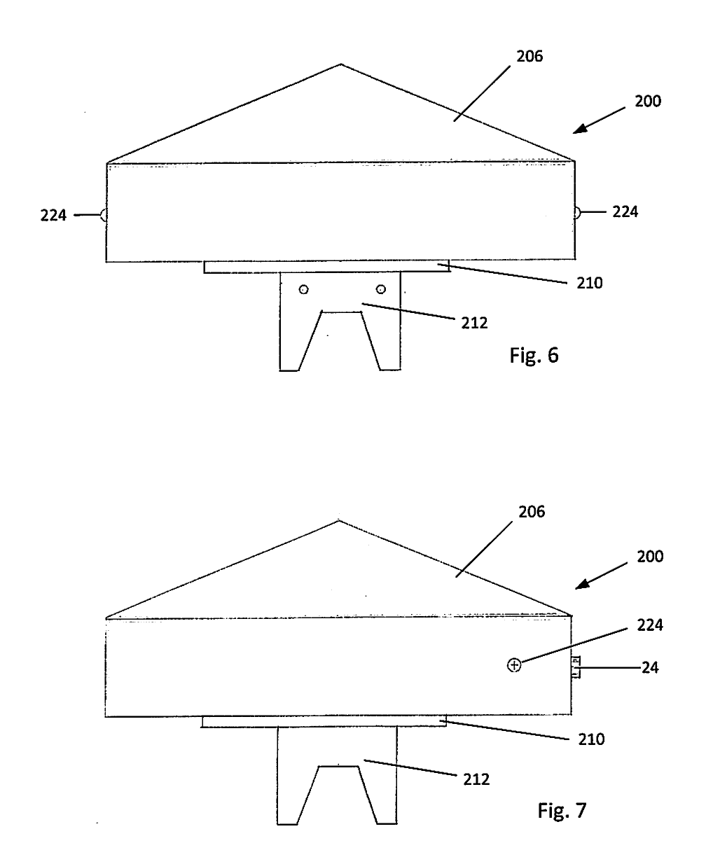

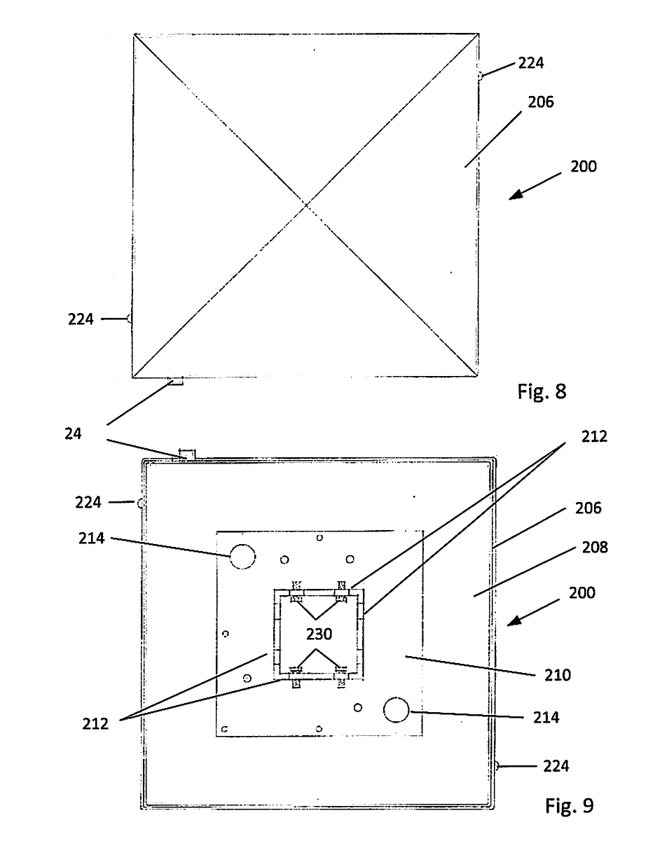

The housing 200 is shown in greater detail in FIGS. 4-9. As shown in FIGS. 4-9, the cap 206 has a pyramidal top, with sidewalls that depend downwardly over upwardly projecting sidewalls of the base 208. Fasteners, such as screws 224 secure the cap 206 over the base 208. The sidewalls of the cap 206 and the base 208 have aligned notches 226, 228 for receiving the photosensor 24, 218. The flanges 212 depend from the bracket 210, and are preferably sized and positioned to fit inside the top of a pole 202. Alternatively the flanges 212 can be sized to fit on the outside of the top of the pole. As shown in FIG. 9, threaded fasteners 230 can be provided on the flange to engage the top of the pole and secure the housing 200 on the top of the pole. The fasteners 230 can be accessed through the bottom of the base, 208, before the cap 206 is secured.

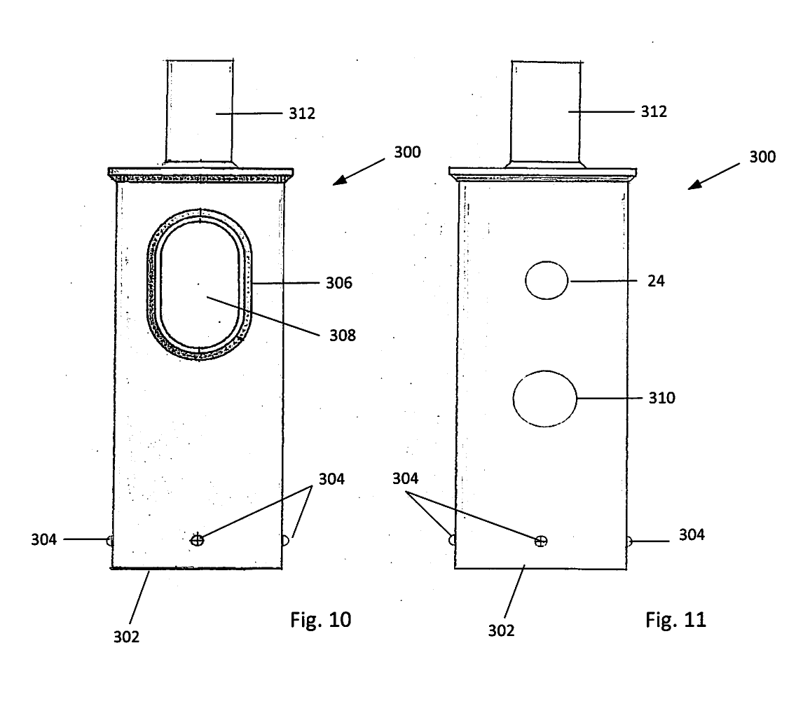

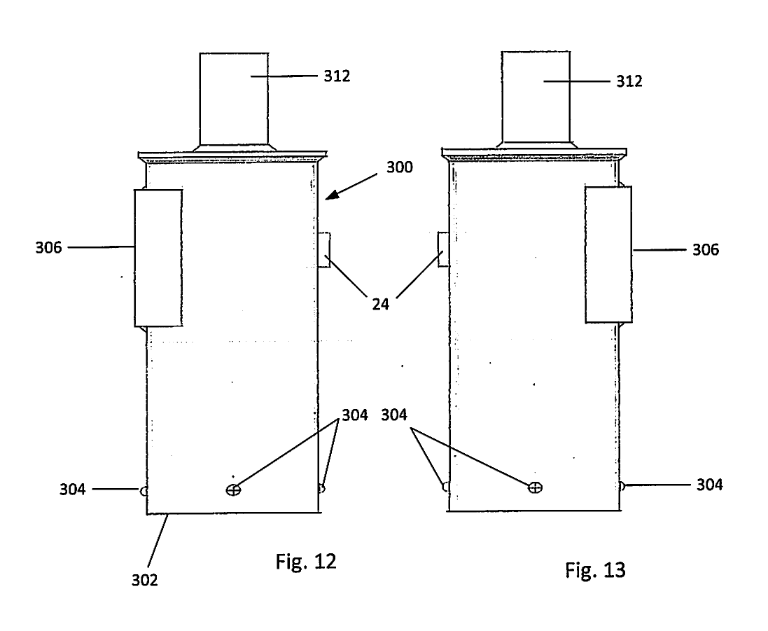

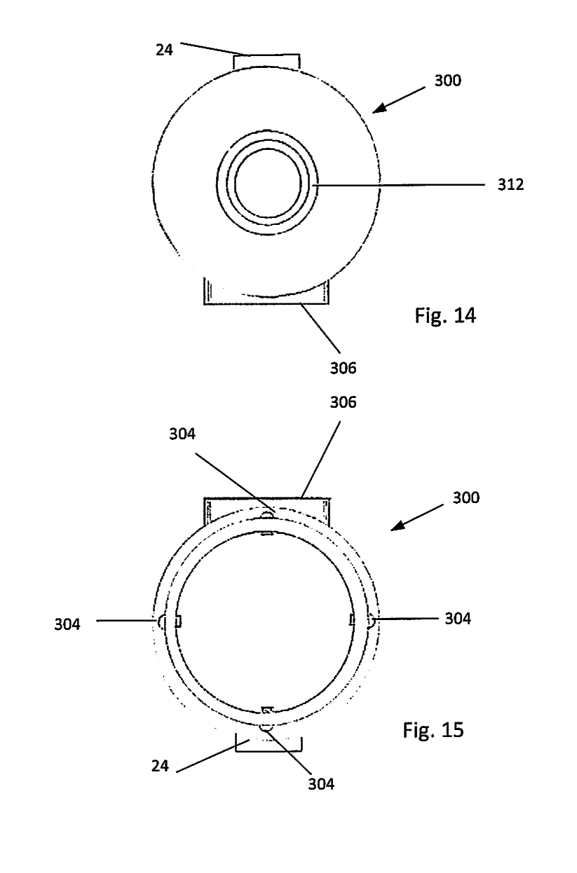

An alternate housing is indicated generally as 300 in FIGS. 10-15. The alternative housing 300 is particularly adapted to be mounted on a round pole supporting a single light. The housing 300 is generally cylindrical, with an open bottom 302 sized to fit over the top of a round pole. A plurality of screws 304 allow the housing 300 to be secure to the pole. The housing 300 has a hand-opening 306, covered with a removable cover plate 308. A photosensor 24 projects from an opening in the back of the housing, adjacent the top. A knock-out 310 or other access opening is provided so that a connection can be made to a photosensor 24. The top of the housing 300 has a tenon 312 for mounting on the light. The housing thus provides a convenient way to retrofit an existing single light with a control in accordance with the principles of this invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of estimating the occurrence of midnight on a given day comprising the steps of:
determining the average night length (NLAVE) by averaging the night lengths (NL) between a night starting time (NST) as determined by a photosensor and a night ending time (NET) determined by a photosensor for each of a plurality of days estimating midnight to occur at the time that is one half of the average night length (NLAVE) after the night starting time (NST) for the given day.

2. The method according to claim 1 wherein the plurality of days for which the average night length (NLAVE) is determined, are a predetermined number of days immediately preceding the given day.

3. The method according to claim 1 wherein the plurality of days for which the average night length (NLAVE) is determined, are the three days immediately preceding the given day.

4. The method according to claim 1 wherein the plurality of days for which the average night length (NLAVE) is determined, are a predetermined number of days immediately preceding the given day whose night length NL meets a predetermined criteria.

5. The method according to claim 1 wherein the plurality of days for which the average night length (NLAVE) is determined, are the three days immediately preceding the given day whose night length (NL) meets a predetermined criteria.

6. A method of controlling the operation of an outdoor lighting system, the method comprising changing the operation of at least one light in the lighting system at a change time that is a selected offset from the estimated occurrence of midnight made by determining the average night length (NLAVE) by averaging the night lengths (NL) between a night starting time (NST) as determined by a photosensor and a night ending time (NET) determined by a photosensor for each of a plurality of days, and estimating midnight to occur at the time that is one half of the average night length (NLAVE) after the night starting time (NST) for the current day.

7. The method according to claim 6 wherein the plurality of days for which the average night length (NLAVE) is determined, are the three days immediately preceding the given day.

8. The method according to claim 6 wherein the plurality of days for which the average night length (NLAVE) is determined, are a predetermined number of days immediately preceding the given day whose night length NL meets a predetermined criteria.

9. The method according to claim 6 wherein the plurality of days for which the average night length (NLAVE) is determined, are the three days immediately preceding the given day whose night length (NL) meets a predetermined criteria.

10. The method according to claim 6 wherein the change in the operation of the light is to operate the light at reduced power unless triggered by a motion sensor.

11. A control for controlling at least one light in an outdoor lighting system, which control can operate with intermittent power, the control comprising:
a relay for operating the at least one light;
at least one photosensor; and
a processor programmed to estimate the occurrence of midnight on the current day by determining the average night length (NLAVE) by averaging the night lengths (NL) between a night starting time (NST) as determined by the at least one photosensor and a night ending time (NET) determined by the at least one photosensor for each of a plurality of days, and estimating midnight on the current day to occur at the time that is one half of the average night length (NLAVE) after the night starting time (NST) for the current day, and operate the relay to control the at least one light at a predetermined period of time offset from the estimated occurrence of midnight.

12. The control according to claim 10 further comprising a motion sensor, and where the relay controls the light to operate under control of the motion sensor.

13. An intermittently powered control for operating at least one light in a lighting system at reduced power after a predetermined time unless triggered by a motion sensor, the control comprising:
a relay for operating the at least one light;
at least one photosensor;
a motion sensor; and
a processor programmed to estimate the occurrence of midnight on the current day by determining the average night length (NLAVE) by averaging the night lengths (NL) between a night starting time (NST) as determined by the at least one photosensor and a night ending time (NET) determined by the at least one photosensor for each of a plurality of days, and estimating midnight on the current day to occur at the time that is one half of the average night length (NLAVE) after the night starting time (NST) for the current day, and operate the relay to control the at least one light at a predetermined period of time offset from the estimated occurrence of midnight.
